(19) United States
(12) Patent Application Publication
(10) Pub. No.: US 2013/0104382 A1
(43) Pub. Date: May 2, 2013

(54) METHOD AND APPARATUS FOR CONVERTING A MIG WELDER INTO A CARBON-ARC CUTTER

(71) Applicants: Darryl Hammock, Brighton, MI (US); Raymond A. Kantola, Brighton, MI (US); Adam Kowall, Highland, MI (US); David Mills, Dearborn Heights, MI (US)

(72) Inventors: Darryl Hammock, Brighton, MI (US); Raymond A. Kantola, Brighton, MI (US); Adam Kowall, Highland, MI (US); David Mills, Dearborn Heights, MI (US)

(21) Appl. No.: 13/656,106

(22) Filed: Oct. 19, 2012

Related U.S. Application Data
(63) Continuation-in-part of application No. 12/775,733, filed on May 7, 2010.
(60) Provisional application No. 61/176,359, filed on May 7, 2009.

(51) Int. Cl. B23K 9/32; B23K 37/00

(52) U.S. Cl. CPC B23K 9/325; B23K 37/00
USPC 29/592.1; 219/74

(57) ABSTRACT

Apparatus and methods convert a MIG welder into an effective cutting machine. A plug adaptor is installed into the existing MIG welder gun cup nozzle, which has an inside diameter and a length. A contact tip within the cup has an outside diameter, and shielding gas ports in the cup typically surround the contact tip. The plug adaptor comprises a body having a width dimension corresponding to the inside diameter of the cup, a length corresponding to the length of the cup, and a central bore corresponding to the outer diameter of the contact tip. A channel is established between the width dimension of the body and the inside diameter of the cup enabling air to flow from the shielding gas ports to a workpiece for slag removal produced during the cutting operation. The MIG gun is not modified in any way except for the addition of the removable adaptor.

### REFERENCE TO RELATED ED APPLICATION

This application is a continuation-in-part of U.S. patent application Ser. No. 12/775,733, filed May 7, 2010, which claims priority from U.S. Provisional Patent Application Ser. No. 61/176,359, filed May 7, 2009, the entire content of both of which is incorporated herein by reference.

### FIELD OF THE INVENTION

This invention relates generally to welding and, more particularly, to apparatus and methods for converting a MIG welder into an effective cutting machine.

### BACKGROUND OF THE INVENTION

MIG (Metal Inert Gas) welding is a semi-automatic or automatic arc welding process in which a continuous and consumable weld wire 108 and a shielding gas 112 are fed through a torch unit 100, depicted schematically in FIG. 1. The process generates heat from an electric weld arc 110 maintained between the consumable weld wire 108 and base material 114. A constant voltage, direct current power source is most commonly used, but constant current systems, as well as alternating current, can be used.

The heat generates a weld puddle 118, depositing a weld bead 116 onto the part 114. The weld wire 108 is delivered through a contact tip 106, whereas the shielding gas 112 is delivered through a gas diffuser 119 contained within a removable nozzle 104 coupled to torch neck insulator 102. Although nozzle 104 is depicted as a simple cylinder, other shapes may be provided for different purposes. A user-operated control (not shown) on the torch unit 100 simultaneously starts the flow of the shielding gas and activates the advancement of the wire feed from a remote roll.

While the MIG process is well suited to joining certain non-ferrous metals, it is poor at cutting. At least one attempt has been made to convert a MIG welder into a better cutting machine. U.S. Pat. No. 5,021,624 describes an attachment coupled to a source of oxygen and includes a manual control for the jet of oxygen used to oxidize and thereby cut the metal. To initiate the cutting action, an electric arc is first established for a short time to sufficiently locally heat the metal so that rapid oxidation will proceed without any further outside source of energy. Thereafter, the oxygen jet directed at the heated metal is turned on and the electric arc turned off or extinguished, with cutting then proceeding at a rapid rate using only the oxygen jet to both oxidize the metal as a source of heat and blow away molten metal to provide a clean, readily controllable cut. The apparatus uses “normal welding wire” as the feedstock.

### SUMMARY OF THE INVENTION

This invention is broadly directed to apparatus and methods for converting an existing metal-inert gas (MIG) welder into an effective cutting machine. Such welders feature a gun cup providing shielding gas around a welding wire, and the preferred method includes the steps of placing an inventive plug adaptor into the gun cup to direct the flow of gas, and replacing the welding wire with inventive wire having a powered-carbon core that strikes a carbon arc to cut a workpiece. The gas provided by the welder is used to blow away slag produced by the cutting operation, and while the shielding itself may be used, the gas feed is preferably switched to air to reduce operating costs.

The plug adaptor is installed into the existing MIG welder gun cup nozzle, which has an inside diameter and a length. A contact tip within the cup has an outside diameter, and shielding gas ports in the cup typically surround the contact tip. The plug adaptor comprises a body having a width dimension corresponding to the inside diameter of the cup, a length corresponding to the length of the cup, and a central bore corresponding to the outer diameter of the contact tip. A channel is established between the width dimension of the body and the inside diameter of the cup enabling air to flow from the shielding gas ports to a workpiece for slag removal produced during the cutting operation.

The body may truncated lengthwise providing the channel between the width dimension of the body and the inside diameter of the cup. In the preferred embodiment, the truncation may be a lengthwise flat on a generally cylindrical plug body. The channel may further include a tapered distal portion to shape the flow of air. The body may be composed of nylon or heat-resistant plastic, and may be machined form a unitary piece of material. The body may further include a distal flange that extends beyond at least a portion of the distal end of the gun cup. The width dimension of the body is the range of ⅜ to 1½ inches, the length dimension in the range of ½ to 2 inches, and the diameter of the central bore in the range of 3/16 to ⅝ inches.

### BRIEF DESCRIPTION OF THE DRAWINGS

FIG. 1 shows a gas nozzle being removed from the MIG torch unit of a welder;

FIG. 2 is a drawing of an air block placed over a contact tip, the device including a body with an attachment bore sized to the contact tip and a manual fastener used to clamp the body in position;

FIG. 3 is a side view that shows the inventive improvement in position during use;

FIG. 4A is a cross section of a plug adaptor with preferred dimensions for one type of gun;

FIG. 4B is a front end view of a plug adaptor with preferred dimensions for one type of gun;

FIG. 4C is an oblique side view of a plug adaptor with preferred dimensions for one type of gun;

FIG. 4D is an oblique front-end view of a plug adaptor with preferred dimensions for one type of gun;

FIG. 5 is a side view in partial cross section showing a plug adaptor installed in the gun cup of a MIG welder;

FIG. 6A is a side view cross section of a plug adaptor having a lengthwise flat and a flange, but without a tapered section; and

FIG. 6B is a rear view of the adaptor of FIG. 6A.

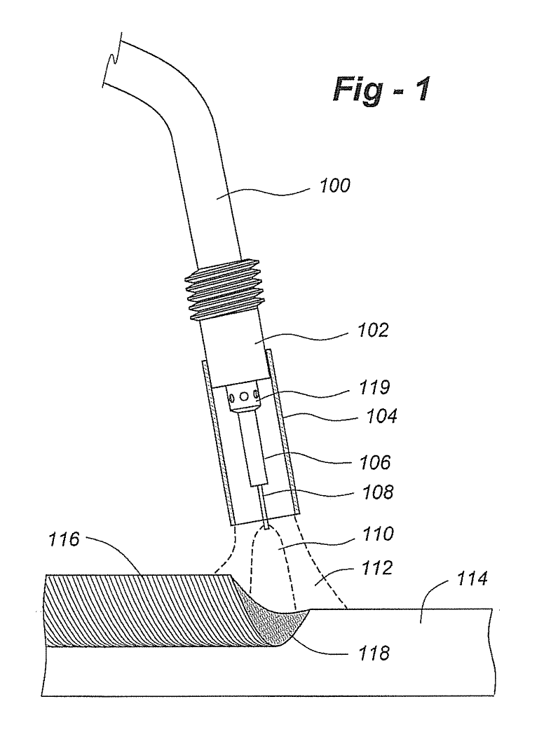

### DETAILED DESCRIPTION OF THE INVENTION

This invention provides apparatus and methods for converting a MIG welder into an effective cutting machine. Unlike the invention described in the '624 patent, this invention does not use “normal welding wire.” Rather, the welding wire is replaced with an inventive wire containing a core with carbon powder. As such, the arc generates considerably more heat, akin to that achieved with a carbon arc cutter. The heat generated is sufficiently high to cut stainless steel and other difficult metal with compressed air, although oxygen may alternatively be used to even greater effectiveness.

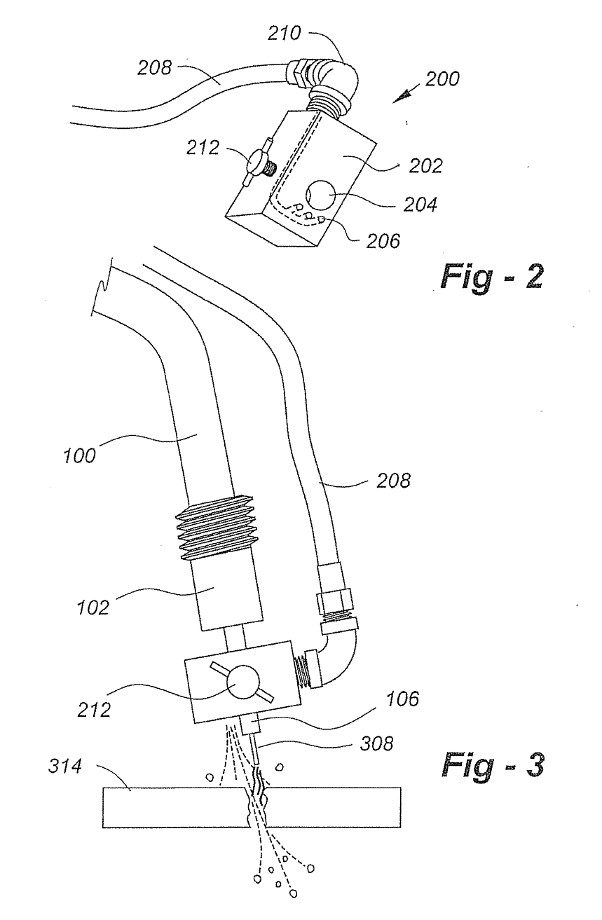

According to the invention, the gas nozzle 104 is removed from the MIG torch unit of the welder and the air block 200 shown in FIG. 2 is placed over the contact tip 106. The device 200 includes a body 202 with an attachment bore 204 sized to the contact tip, with a manual fastener 212 being used to clamp the body in position.

The body 202 includes a gas/air inlet line 208 coupled to the body through a fitting 210. Although a right-angle fitting is shown other connectors may alternatively be used. Cavities formed in the body 202 allow the gas or air to exit through ports 206, preferably substantially parallel to the axis of attachment bore 204. Although three ports 206 are shown on one side, other arrangements are possible, including ports surrounding attachment bore 204.

FIG. 3 is a side view that shows the inventive improvement in position during use. A high-temperature arc is created by wire 308, with air from the ports being operative to blow away molten metal particles. In operation, the gas to the body 202 may be turned on in advance, with the user-operated control on the welder hand unit being used to advance the wire 308 during the cutting process. Alternatively, an electrical circuit may be provided to turn on the gas automatically when the hand unit control is activated.

As mentioned, normal welding wire is not used in accordance with the invention. In particular, the wire used is a composite cored wire comprising a mild steel jacket surrounding a core of compacted high-energy carbon powder. The carbon may be supplied in the form of natural or synthetic graphite (coke), preferably in the range of 30-200 mesh. So-called ‘air-floated’ graphite may be used in the 325-400 mesh range.

The graphite carbon provides the necessary electrical resistance to achieve cutting temperatures comparable to those seen in carbon-arc cutting. Additives may also be used to enhance effectiveness. For example, iron oxide or iron carbonate (i.e., in the 200-mesh range) may be added to accelerate delivery force. Aluminum or magnesium powder additives (i.e., in the 30×200 mesh range) may also provide a beneficial accelerant effect. Fluorides such as calcium or sodium fluoride (i.e., in the 30×325 mesh range) may enhance metal “flow” by lowering surface tension.

The product and process offer distinct advantages over the use of standard carbon or graphite electrodes. Such advantages include the following:

The ability to bum or remove metal on a continuous basis, not having to reposition the electrode after only a short while in operation.

Product is fed continuously from large spools (i.e., 60 lb coils or 500 lb drums) as with MIG welding wire.

The ability to use standard welding machine along with compressed air-no special holder is required.

The ability to remove narrow strips of metal at a rapid rate either completely through a plate or by gouging to certain depths.

Plate thickness, alloy content or depth is immaterial.

Noise level is reduced dramatically as compared to carbon-arc technology; sounds like a welding operation.

Carbon blow-by reduced dramatically providing a cleaner working environment, resulting in a more environmentally ‘green’ process.

No broken pieces or wasted electrodes which are common with standard product.

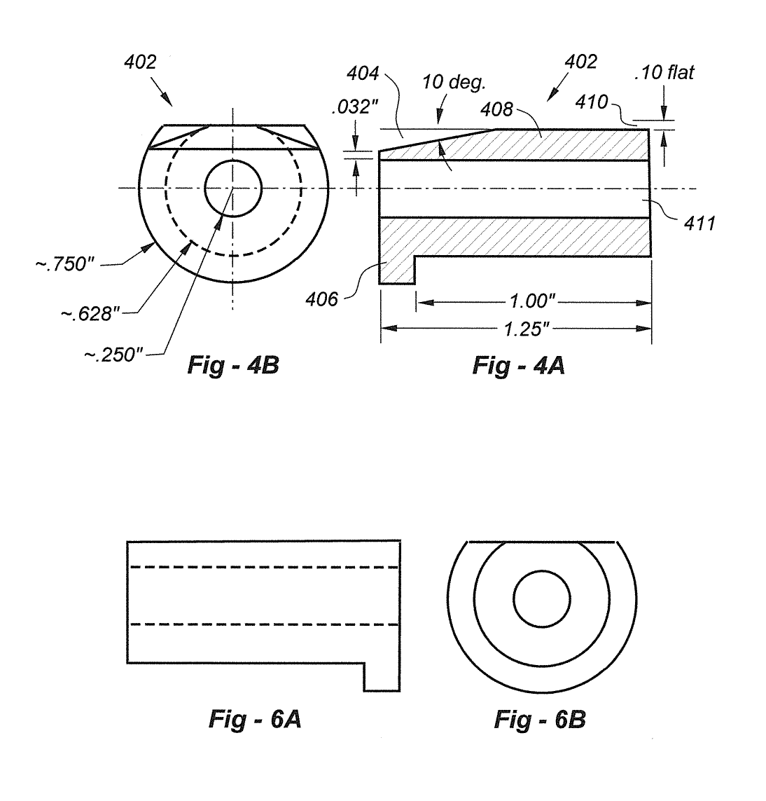

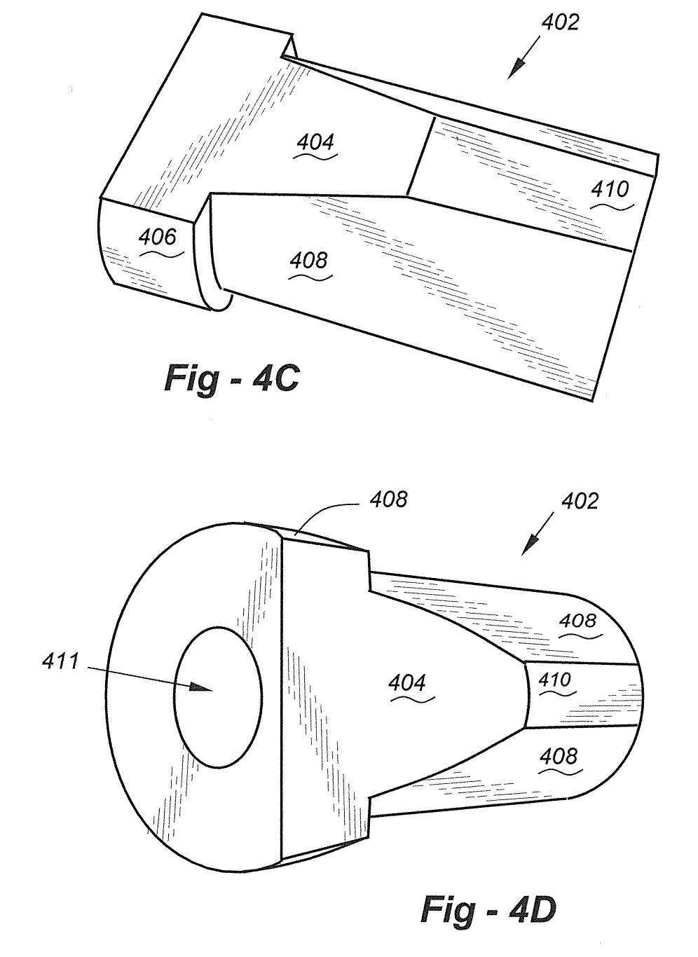

FIGS. 4-6 illustrate embodiments of the invention that forgo the need for air block 200 and associated tubing, instead using a custom designed and fabricated plug adaptor configured to fit inside an existing MIG welding gun cup. This allows the use of the existing shielding gas distribution routes of the welding system to the tip of the gun and cutting zone. As with the previously described embodiments, the system uses inventive carbon-powder-jacketed wires disclosed herein instead of welding wire to achieve carbon arc cutting temperatures. Although the inert shielding gas may be used for slag blow-off, the gas supply is preferably switched to shop air to lower operational cost.

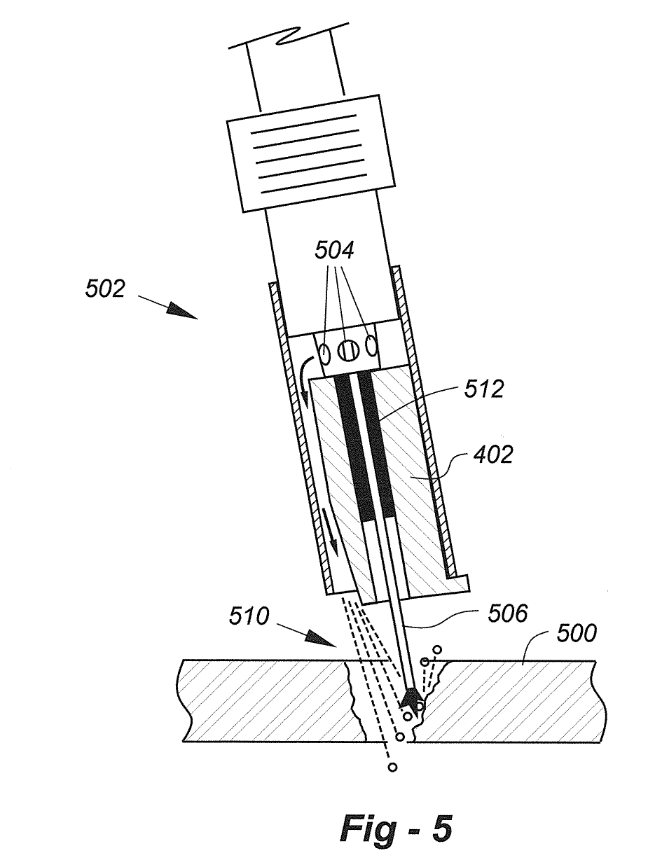

FIG. 4A is a cross section of a plug adaptor 402 with preferred dimensions for one type of gun 502 shown in FIG. 5. FIG. 4B is a front end view. FIG. 4C is an oblique side view, and FIG. 4D is an oblique front-end view. This particular embodiment includes a generally cylindrical body 408 with a truncation 410 in the form of a lengthwise flat, to allow gas to flow from outlets 504 of gun 502, and through the truncated region to the work site 510 as shown by the arrows. While this truncation is provided in most designs, it may not be necessary with certain gun cups that flare outwardly; that is, wherein the diameter of the distal end of the cup is somewhat larger than the proximal region of the cup, thereby inherently establishing a gas-flow channel.

All plug adaptor embodiments feature a central bore 410 configured to receive the contact tip 512 of the gun, typically of copper construction. The inventive jacketed carbon-powder wire 506 advances through the contact tip 512 while cutting workpiece 500. Optional tapered region 404 may be provided to improve the direction of air flow to the cutting region 510, however the tapered region may be eliminated in certain gun designs as shown in FIGS. 6A and 6B. Flange 406 is optional as well, but allows the plug to be more easily removed and/or turned to adjust the direction of air flow.

The plug adaptor is preferably of a unitary construction, fabricated through machining. It is preferably constructed from nylon, machined to the dimensions appropriate for a particular welding gun design. Various other materials may alternatively be used for the adaptor, including heat-resistant plastics, metals or ceramics. In all cases, the plug is held in position through dimensions corresponding the geometries of the gun cup and contact tip, resulting in a frictional or snug removable “press fit.”

There are numerous different styles of MIG guns on the market. As such, different plug adaptors will be provided in accordance with the invention depending upon the tip design. Accordingly, while the dimensions called out in FIGS. 4A and 4B are used for the gun shown in FIG. 5, such dimensions may vary considerably. For instance, the width or diameter of the cylindrical body portion, shown as 0.628″, may be in the range of ⅜ to 1½ inches. The length of the cylindrical body portion, shown at 1″, may vary from ½ to 2 inches. The central bore, shown as 0.250″ may be in the range of 3/16 to ⅝ inches, depending upon the diameter of the contact tip.

The plug-adaptor embodiments thus described are preferred for a variety of reasons. First, the MIG gun is not modified in any way except for the addition of the removable plug adaptor. The machined adaptor is used to control the direction and amount of air flow, allowing the operator to maintain a desired flow of air between the wire and the workpiece for optimum slag removal. The existing air control valve and gage assembly with quick-disconnect fitting at the welder feeder may be used where the gas enters the system. This facilitates the use of shop air through the existing, installed wire feeder gas solenoid and delivery system. The available quick-disconnect fittings enable an operator to switch between welding with shielding gas and conventional welding wire to cutting with shop air and the inventive carbon powder encased wire in a matter of minutes. The inventive high energy/temperature cutting wire is activated by the same “trigger” of the gun, which also activates the air flow.

We claim:

1. A plug adaptor for converting an existing MIG welder into a carbon-arc cutter, the existing welder having a gun cup nozzle with a inside diameter and a length, a contact tip within the cup having an outside diameter, and shielding gas ports in the cup surrounding the contact tip, the plug adaptor comprising:
a body physically configured for removable placement within the gun cup of the welder;
the body having a width dimension corresponding to the inside diameter of the cup, a length corresponding to the length of the cup, and a central bore corresponding to the outer diameter of the contact tip; and
wherein a channel is established between the width dimension of the body and the inside diameter of the cup enabling air or other slag removal gas to flow from the shielding gas ports to a workpiece being cut.

2. The plug adaptor of claim 1, wherein the body is truncated lengthwise to establish the channel between the width dimension of the body and the inside diameter of the cup.

3. The plug adaptor of claim 1, wherein:
the body is truncated lengthwise to establish the channel between the width dimension of the body and the inside diameter of the cup; and
the channel further includes a tapered distal portion to shape the flow of gas used for slag blow-off.

4. The plug adaptor of claim 1, wherein the body is composed of nylon or heat-resistant plastic.

5. The plug adaptor of claim 1, wherein the body is machined form a unitary piece of material.

6. The plug adaptor of claim 1, wherein the body further includes a distal flange that extends beyond at least a portion of the gun cup.

7. The plug adaptor of claim 1, wherein the width dimension of the body is the range of ⅜ to 1½ inches.

8. The plug adaptor of claim 1, wherein the length dimension of the body is the range of ½ to 2 inches.

9. The plug adaptor of claim 1, wherein the diameter of the central bore is in the range of 3/16 to ⅝ inches.

10. The plug adaptor of claim 1, wherein the body is generally cylindrical the range of ⅜ to 1½ inches.

11. The plug adaptor of claim 1, wherein:
the body is generally cylindrical; and
the diameter of the body is in the range of ⅜ to 1½ inches.

12. A method of converting a metal-inert-gas (MIG) welder having a gun cup providing inert shielding gas around a welding wire into a carbon-arc cutter, the method comprising the steps of:
placing the plug adaptor of claim 1 into the gun cup of the MIG welder;
replacing the welding wire with a wire having a powered-carbon core; and

13. The method of claim 12, further including the step of using air or oxygen instead of the welder's inert shielding gas.
